(19) United States
(12) Patent Application Publication
(10) Pub. No.: US 2006/0162233 A1
(43) Pub. Date: Jul. 27, 2006

(54) Fishing rod float

(76) Inventor: Alfredo Hueso Pajares, Madrid (ES)

Correspondence Address: Alfredo Hueso Pajares, C/ Victor De La Serna 3-5 (Parking), Madrid, 28016, ES

(21) Appl. No.: 10/530,183

(22) PCT Filed: Oct. 8, 2002
(86) PCT No.: PCT/ES02/00473

§ 371 Date: Apr. 4, 2005

(51) Int. Cl. A01K 93/00

(52) U.S. Cl. 43/44.91; 43/44.87; 43/44.9

(57) ABSTRACT

The invention relates to a fishing rod float in which one half-section (1) is stacked on top of another half-section (2). In this way, a longitudinal through hole is formed in the float for the fishing line, through the joining of two grooves (3, 4). In addition, a rod is inserted into the aforementioned hole in order to clamp the line and fix same.

### OBJECT OF THE INVENTION

The present float for fishing rods is based on the design of a float or buoy, mainly through the union of two semiparts that clasp the rod together with the line that hangs from the fishing rod rigging, so that the union is guided by one of the semiparts sliding with respect to the other, thus allowing the line to pass through and standard use for fishing at the same time, said semiparts being mountable and dismountable at will.

### BACKGROUND OF THE INVENTION

To date, in the state of the art of rod fishing, standard floats or buoys are used, which are pierced lengthways with a narrow orifice, through which fishing line is threaded, which joins together the hook and rigs on one end and the fishing rod at the other, this line being attached by its corresponding rod to the inner surface of the orifice of the float, holding the rigging fixed thereby depending on the depth at which one wishes to fish and also the fishing conditions.

Although, this is one widely used system due to its simplicity and economical price, it is also true that it brings about several drawbacks, mainly when the float has to be replaced whether due to deterioration, or because a different float is required because new or different fishing conditions are met.

For this operation the whole rigging must be dismounted, that is, the rod which fastens the line has to be freed, the hook and weight have to be dismounted, etc., the float must be changed, and afterwards the whole rigging must be assembled again. This operation may take, depending on the complexity of the parts and the dexterity of the user, between 10 and 20 minutes. This amount of time is considerably long taking into account that the operation may have to be repeated on several occasions throughout a single fishing session. Without considering the risk of manipulating the hook, changing the bait, etc.

### DESCRIPTION OF THE INVENTION

With the fishing rod float, object of the present invention, all of these drawbacks are intended to be avoided or decreased, for this purpose it is based on a formation of a float or buoy made up of two assemblable parts, which compose the hollow inner conduct through which the fishing line passes, and into which is also inserted the rod that holds the line and preventing its involuntary sliding.

The float is divided into two parts which, once assembled, form the body of the float, that is, with the inner passage for the line to pass through. Its assembly is carried out preferably with a dovetail system, in which entrances of one of the parts slide along projections or tracks of the other part, providing a stopper that situates them together in position.

This float is place around the line, which implies that it is not necessary to dismount the whole rig in order to change the buoy or float, but rather by just loosening the rod to block the orifice and disassemble both parts of the float, one may free the cork rigging; in order to join the two pieces of the float to be put on afterwards. This operation may take about 20 to 40 seconds to carry out, considerably favouring the task and avoiding it meaning a tedious float changing process.

Therefore, a set of float sizes and different features can be available when they may need to be used, without their substitution bringing about any drawbacks or difficulties, thus facilitating trying different ones until the most appropriate is found. This is possible because the labour time is minimal.

### DESCRIPTION OF THE DRAWINGS

In order to complete the present description and with the objective of providing an improved understanding of the characteristics of the invention, the present disclosure is accompanied by a series of figures in which, with a strictly illustrative, non-limiting purpose, the following is represented:

FIG. 1: Raised, plan and profile view of a semipart of the float, object of the present invention.

FIG. 2: Side perspective view of the semipart shown in FIG. 1.

FIG. 3: Raised, plan and profile view of the other semipart of the float, object of the present invention.

FIG. 4: Upper side perspective view of the semipart shown in FIG. 3.

FIG. 5: Upper perspective view of a pre-assembly of both semiparts of the float.

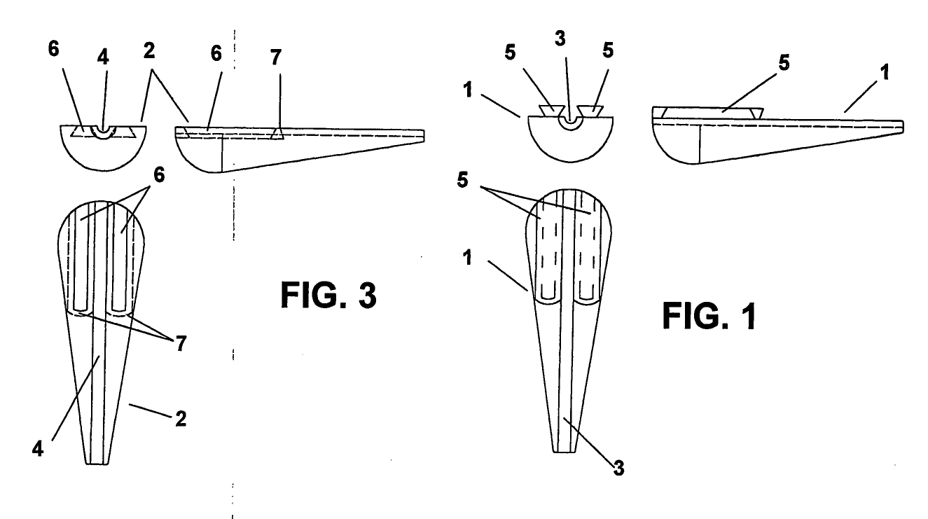

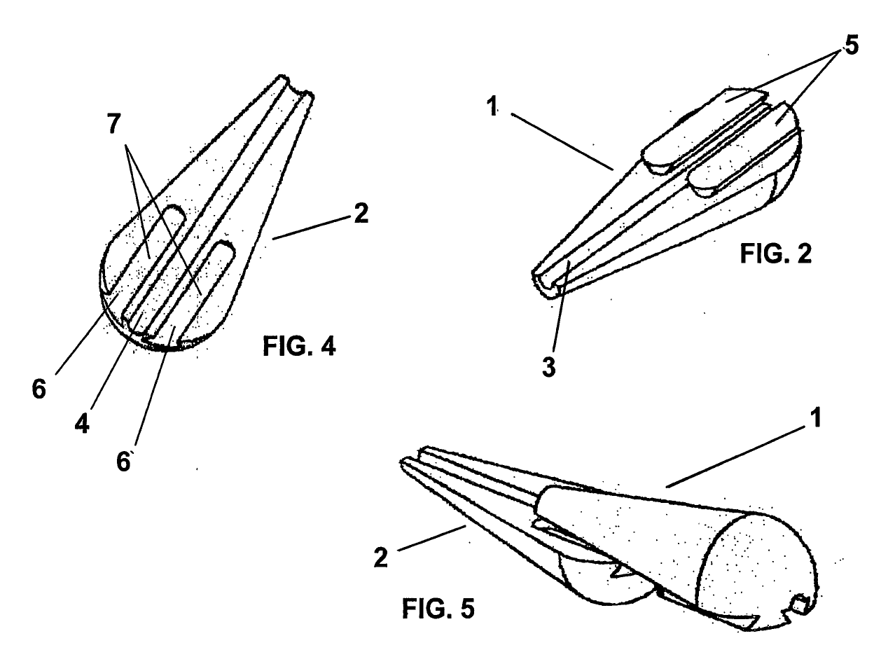

### PREFERRED EMBODIMENT OF THE INVENTION

As can be seen in the attached figures, it is characterised firstly by a part or semipart (1) of the body of the float, and the other semipart (2), which carry, respectively, a lengthways groove (3,4). The semipart (1) is provided with projections (5) that run partially along the length of said semipart.

On the contrary, the semipart (2) is provided with a slotted area (6) that also runs lengthways with the axis of the semipart (2) but partially, said slot corresponding to the projection (5) of the other part, in size and in proportions, so that it facilitates sliding one part on the other by assembling this slot (6) and projection (5) system, which make up the guide track system.

Another possibility of the same invention is based on each of the semiparts (1,2) being provided with both a projection (5) and a slot (6), arranged so that they facilitate inserting the projection (5) in the corresponding slot (6) of the complementary semipart.

The arrangement of the lengthways groove (3) of semipart (1) corresponds with groove (4) of semipart (2) so that, once joined, they form the orifice through which the fishing line slides, and through which the fastening rod is introduced.

The slot (6) houses a stopper (7), which acts against the end of the projection (5) when it is inserted, thus obtaining in this position the final forming of the body of the float, prepared for use. The materials are those habitually used for these products.

Its use and function is quite simple, in order to dismount it from the fishing rod, the rod is simply freed, leaving it loose both semiparts (1,2) are slid against one another lengthways until the two are free of fishing line, thus facilitating the assembly of the corresponding float.

In order to do so, the line is place in the groove (3 or 4) of one of the semiparts (1 or 2, respectively), the projections (5) of one of these semiparts are placed so as to coincide with the entrances or slot (6) of the other, for which their respective formations correspond to one another; a semipart is slid over the other to its final stop position (7), the float being thus completely formed and only needing the line to be attached with the fastening rod in order for the rigging to be assembled and ready for use.

Having sufficiently described the nature of the present invention, as well as a practical embodiment of the same, it only needs to be added that changes may be introduced into both the shape and the materials and design of the same, as long as said changes do not substantially affect the features claimed below:

1.) Fishing rod float, of the kind used in order to prevent the fishing line from sinking and marking the fishing point and that are formed by two connecting semi-parts (1, 2) of the body of the float, charaterised in that:
each said semi-part (1, 2) of the body of the float has a lengthways groove (3,4), located in the longitudinal axis of the connecting face of each said semi-part (1, 2) of semi-circular section, in such a way that when each of the semiparts (1, 2) unite the body of the float features a longitudinal orifice, located in the longitudinal axis of the float, of circular section through which the fishing line is to slide:
said semipart (1) has two projections (5) for the union of the semiparts (1, 2), with dovetail section, located with its edges parallel to the longitudinal axis of said semi-part (1) at each side of said longitudinal axis and at equal distances, having said projections (5) the same length and substantially less than said semipart (1);
said semipart (2) has two slots (6) for the union of the semiparts (1,2), with dovetail section, located with its edges parallel to the longitudinal axis of said semi-part (2) at each side of said longitudinal axis and at equal distances and having said slots (6) the same length and substantially less than said semipart (2), and having said slots (6) stoppers (7) that act against the ends of the projections (5) when said projections (5) are inserted in the slots (6);

2.) Fishing rod float according to claim 1, characterised in that the slots (6) correspond with the projections (5) in size and proportions, so that they facilitate the union of said semiparts (1, 2) by parallely sliding the projections (5) into the slots (6) up until the limit set by said stoppers (7)
